(19) United States
(12) Patent Application Publication
(10) Pub. No.: US 2003/0174730 A1
(43) Pub. Date: Sep. 18, 2003

(54) Data link control device

(76) Inventors: Yu-Jen Hsueh, Taoyuan (TW); Hsi-Kun Chen, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/264,582

(22) Filed: Oct. 4, 2002

(30) Foreign Application Priority Data
Mar. 13, 2002 (TW) 91104790

(51) Int. Cl. H04J 3/16; H04J 3/22

(52) U.S. Cl. 370/469

(57) ABSTRACT

A data link control device which is implemented in a Layer 2 Protocol of a subscriber unit in order to establish and maintain data link between the subscriber unit and a radio port. In which, the Layer 2 Protocol is located between a physical layer and a Layer 3 Protocol. The data link control device comprises a media access control module, a state control module and a data processing module. The media access control module transmits and receives data between the subscriber unit and the radio port. The state control module controls and manages the flow of states of the subscriber unit. States in the state control module can be classified as Off State, Acquiring State, Standby State, and Active State. According to system information channel (SIC) message and alerting channel (AC) message received, or requests from the state control module, the data processing module carries out corresponding actions to the state control module. Also, the data processing module uses acknowledged mode transfer (AMT) communication protocol and through the media access control module, uplinks and downlinks information to and from a radio port control unit, in order to transmit information of Layer 3 Protocol between the subscriber unit and the radio port control unit. In which, the AMT communication protocol instructs the information receiver to feed back the correctness of the information transmitted.

### BACKGROUND OF THE INVENTION

1. Field of the Invention

The invention relates to a data link device and, more particularly, to a data link control device that centrally controls the states of a subscriber unit, and uses modularized concept to distinguish state control from data control.

2. Description of the Related Art

Along with the progress in wireless communication technology, a subscriber unit has become one of the most popular communication tools. In a subscriber unit, the communication protocol can normally be divided into three layers. The first layer is a physical layer, which uses a transmission media to carry out actual data transmission. Layer 3 Protocol executes procedures for registering and dialing, receiving, and disconnecting calls in a wireless communication device. Layer 2 Protocol is in charge of establishing data link, maintaining and releasing the link.

FIG. 1 shows the structure of a personal access communications system (PACS), which will be used as an example in the following description of the invention. A PACS system comprises one or more subscriber units (SUs) 1, one or more radio ports (RPs) 2, and one or more radio port control units (RPCUs) 3. The subscriber unit 1 carries out data transmission with RP 2 by means of a wireless communication method. RPCU 3 controls the operation of RP 2. RPCU 3 is further connected to a public switched telephone network 4.

The preliminary tasks for establishing a data link includes: scanning frequencies to look for a suitable RP channel, receiving a system information channel (SIC) from RP, seizing a traffic channel (TC), or receiving a alerting channel (AC), etc. Furthermore, in order to complete the above-mentioned tasks, Layer 2 Protocol is further required to handle tasks such as measuring received signal strength indication (RSSI), monitoring signal quality, detecting synchronization states, identifying transmission information, proceeding to time slot transfer, proceeding to automatic link transfer, and transmitting and receiving information using methods of acknowledged mode transfer (AMT). Among these, it involves complicated data transmission and state management, and hence, the design and implementation of Layer 2 Protocol has always been one of the key factors that determines the communication quality of a subscriber unit.

In order to complete the above-mentioned tasks, it is necessary to manage states of the subscriber unit, and to handle various types of data transmission. For this, it often causes inappropriate link between functions of state management and data transmission, which leads to implementation problems of difficulties in debugging and designing, or even causes bad communication quality for a subscriber unit, such as low connection rate, or information interruption due to data link transfer failed.

Therefore, as mentioned above, there is a strong need in the art to appropriately distinguish functions for state management and data transmission, and effectively establishing and improving stability of data link, in order to improve the quality of telecommunication.

### SUMMARY OF THE INVENTION

In view of the above-mentioned problems, one object of the invention is to provide a data link control device, which uses modularized concept to distinguish state management from data transmission, in order to effectively establish and control stability of data link.

In order to achieve the above-mentioned object, the data link control device of the invention is implemented on a Layer 2 Protocol of a subscriber unit (SU), to establish and maintain data link between the SU and a radio port (RP). The Layer 2 Protocol is situated between a physical layer and a Layer 3 Protocol. The data link control device includes a media access control module, a state control module, and a data processing module.

The media access control module transmits and receives data between an SU and an RP. The state control module controls and manages the flow of states of the SU. The states of the state control module can be classified as Off State, Acquiring State, Standby State, and Active State. The data processing module based on the system information channel (SIC) and alerting channel (AC) information received, or based on the instruction of the state control module, carries out corresponding actions to the state control module. Also, the data processing module uses acknowledged mode transfer (AMT) communication protocol, and through the media access control module, uplinks and downlinks information to and from the radio port control unit, in order to transmit information of Layer 3 Protocol between the SU and the radio port control unit.

The data link control device of the invention separates the functions of state management and data transmission, uses a function module to centrally control states of an SU, and clearly distinguishes between data processing, and data transmitting and receiving. For this, it effectively establishes and controls the stability of data link, and therefore improves the quality of telecommunication.

### BRIEF DESCRIPTION OF THE DRAWINGS

FIG. 1 is a diagram illustrating the structure of a personal access communications system (PACS).

FIG. 2 is a diagram illustrating the structure of a subscriber unit in accordance with one embodiment of the invention.

FIG. 3 is a diagram illustrating the structure of a data link control device in accordance with one embodiment of the invention.

FIG. 4 is a schematic diagram illustrating relationships between states of a state control module in accordance with one embodiment of the invention.

FIG. 5 is a schematic diagram illustrating eight events that need to be executed by a data processing module in accordance with one embodiment of the invention.

FIGS. 5A to 5H are flow charts illustrating each of the eight events shown in FIG. 5.

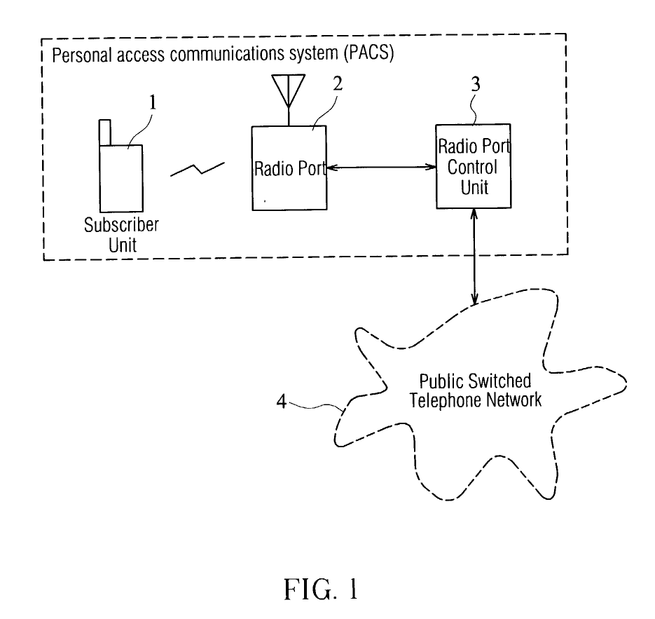

### DETAILED DESCRIPTION OF PREFERRED EMBODIMENT

Referring now to the drawings, in which same numerals represent same elements, a data link control device in accordance with a preferred embodiment of the invention will be described.

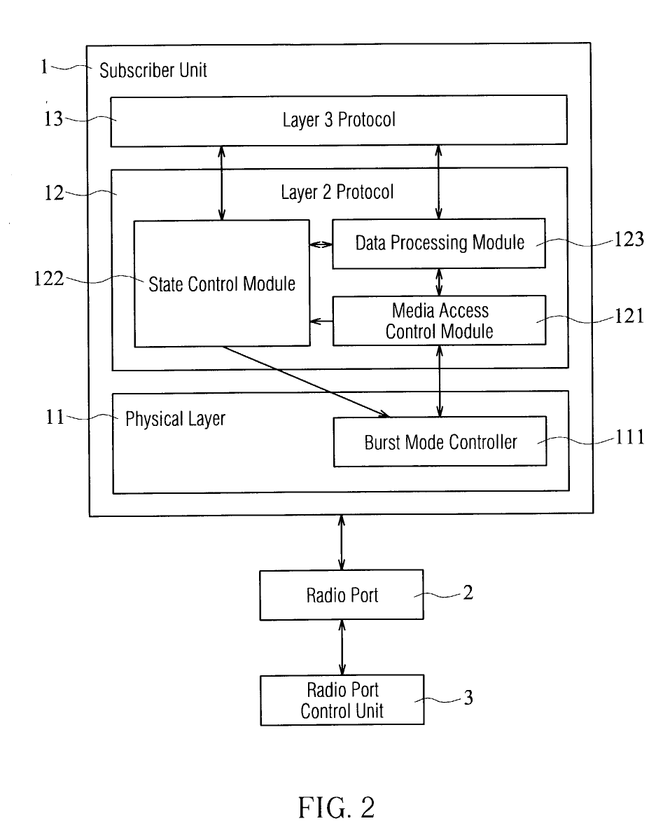

As shown in FIG. 2, the data link control device in one embodiment of the invention is implemented in a Layer 2 Protocol 12 of a subscriber unit 1 to establish and maintain data link between the subscriber unit 1 and the radio port 2. The subscriber unit 1 further includes a physical layer (that is, Layer 1 Protocol 11) and a Layer 3 Protocol 13. The physical layer 11 carries out actual data transmission tasks through a transmission media. It includes a burst mode controller (BMC) 111, which works as an interface between the physical layer 11 and the Layer 2 Protocol 12. The Layer 3 Protocol 13 executes procedures for registering, and dialing, receiving, and disconnecting calls in the subscriber unit 1.

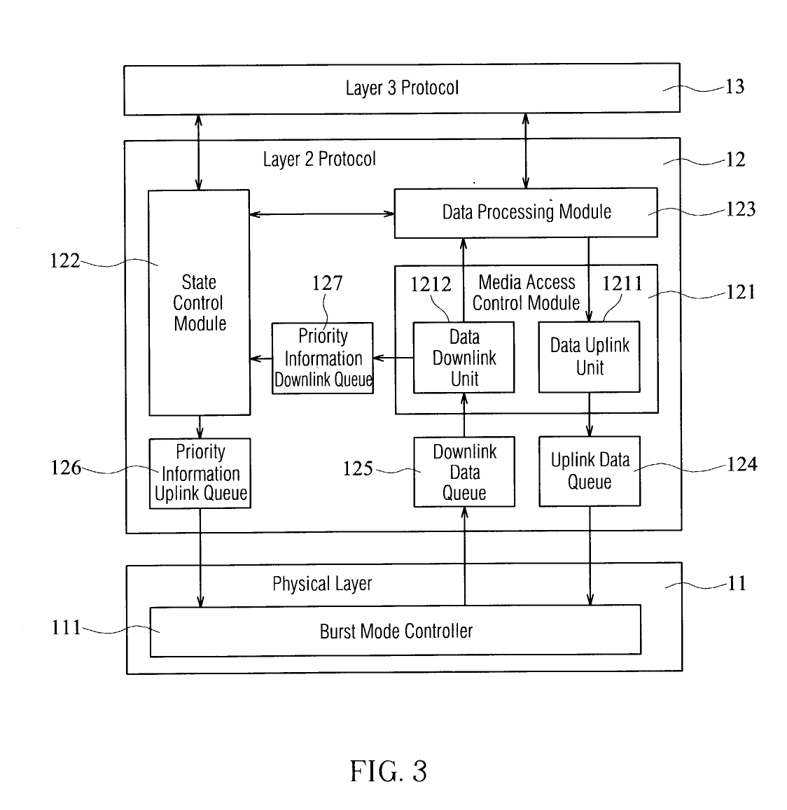

As shown in FIG. 3, the data link control device in one embodiment of the invention includes a media access control module 121, a state control module 122, a data processing module 123, an uplink data queue 124, a downlink data queue 125, a priority information uplink queue 126, and a priority information downlink queue 127.

The media access control module 121 transmits and receives data between the subscriber unit 1 and the radio port 2 through the BMC 111. The media access control module 121 includes a data uplink unit 1211 and a data downlink unit 1212. From the BMC 111 of the Layer 1 Protocol, the media access control module 121 downlinks information including acknowledged mode transfer (AMT) message, system information channel (SIC) message, alerting channel (AC) message, and Layer 2 Protocol message, through the downlink data queue 125 to the data downlink unit 1212. The data uplink unit 1211 uplinks AMT message through the uplink data queue 124 to the BMC 111. In which, Layer 2 Protocol message means information of requests of establishing (or seizing) traffic channel, acknowledgement to proceed to automatic link transfer or time slot transfer and priority request control, etc. The data uplink unit 1211 obtains uplink message (i.e. AMT message) from the data processing module 123, splits it into a suitable length (in this embodiment the length is usually 10 bytes), and then transmits it to the BMC 111 of the Layer 1 Protocol through the uplink data queue 124. The data downlink unit 1212 obtains downlink information from the BMC 111 through the downlink data queue 125. The data downlink unit 1212 transmits assembled and collated AMT message, SIC message or AC message, through the downlink data queue 125, to the data processing module 123, which will be described later. The data downlink unit 1212 also transmits separately the Layer 2 Protocol message of downlink information that has been assembled and collated to the state control module 122, as described later, through the priority information downlink queue 127.

A state control module 122 controls the flow of states of the subscriber unit 1 during the process of transmitting information between the Layer 1 Protocol 11 and the Layer 3 Protocol 13, and during the process of uplink and downlink information. The state control module 122 transmits message of the Layer 2 Protocol 12 to the Layer 1 Protocol 11 through the priority information uplink queue 126. As for the BMC 111, information obtained from the priority information uplink queue 126 has the priority right over the uplink data queue 124 and therefore must be processed first. When the Layer 1 Protocol feeds back in response to the message of the Layer 2 Protocol 12, the message of the Layer 2 Protocol is downlink to the state control module 122 through the downlink data queue 125, the data downlink unit 1212 and the priority information downlink queue 127 successively.

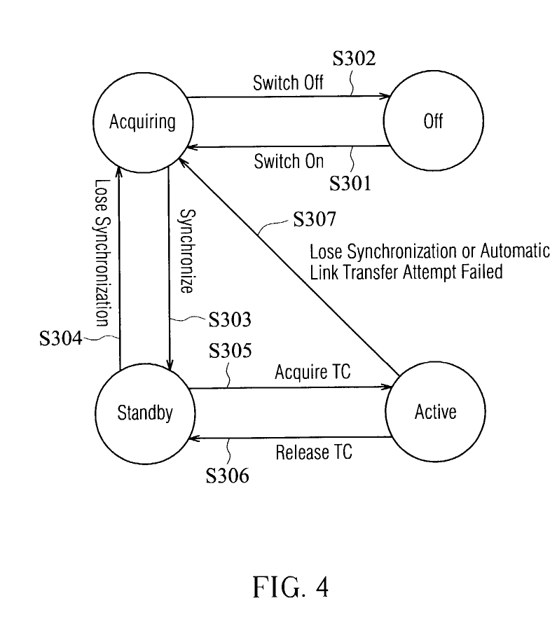

As shown in FIG. 4, the states of the state control module 122 can be classified as Off State, Acquiring State, Standby State and Active State. The Off State indicates that the subscriber unit 1 is not switched on. When it is switched on from the Off State, the subscriber unit 1 enters the Acquiring State and starts to scan frequencies to select a suitable radio port channel. When the subscriber unit 1 is synchronized successfully with a system broadcast channel (SBC) of the radio port 2, it starts to receive necessary message such as SIC and then, after the completion of acquiring synchronization (S303), enters the Standby State. It should be noted that the SBC comprises a system information channel (SIC). In the Standby State, the subscriber unit 1 is continuously monitoring SBC and determining whether registration is required in order to obtain an Alerting ID from the radio port control unit 3. If the subscriber unit 1 is synchronized successfully with a traffic channel (TC), that is, communication is commenced (S305), the subscriber unit 1 then enters the Active State. If the TC is released through a normal procedure, that is, communication is terminated (S306), the subscriber unit 1 is returned to the Standby State. If it lost synchronization or failed to perform automatic link transfer during the Active State (S307), or lost synchronization during the Standby State (S304), the subscriber unit 1 is returned to the Acquiring State and keeps searching for a suitable radio port channel. If it is switched off during the Acquiring State (S302), the subscriber unit 1 is returned to the Off State. It is the same for switching off during the Standby State and the Active State.

In the Standby State, the following tasks are performed by the state control module 122. First, when entering the Standby State from the Acquiring State, it needs to wait for the completion of receiving SIC message transmitted from the radio port control unit 3. Secondly, it waits for the request of establishing TC from the Layer 3 Protocol 13, or notifies the Layer 3 Protocol 13 of an incoming call acknowledged by the data processing module 123. Thirdly, through the priority information uplink queue 126, it sends an inquiry signal to the radio port control unit 3 to check whether the TC can be used. Fourthly, it keeps scanning channels for radio port 2 and testing signal quality such as RSSI and quality indication (QI), and establishing a list of candidate channels to be used for automatic link transfer (i.e. handover) or time slot transfer during the Active State. Fifthly, it activates a power saving mode which keeps only crucial elements such as the microprocessor working, all other elements are switched off. Sixthly, under the emergency situation that no TC is available, it uses the state control module 122 through priority information uplink queue 126 to transmit PRC information to the BMC 111 in Layer 1 Protocol 11.

Under the Active State, the state control module 122 continuously scans channels for radio port 2 and measures the signal quality such as RSSI and QI, and establishes a list of candidate channels. If the signal quality of the subscriber unit 1 has fallen below a threshold value, the priority information uplink queue 126 acknowledges to proceed to the automatic link transfer or time slot transfer of message.

The data processing module 123 manages SIC and AC message downlink from radio port control unit 3. The data processing module 123 based on the SIC and AC message received, and in accordance with requests from the state control module 122, carries out corresponding actions to the state control module 122. In addition, the data processing module 123 uses AMT communication protocol, through the media access control module 121, to uplink and downlink information to and from the radio port control unit 3. Through this, the data processing module 123 transmits information of the Layer 3 Protocol between the subscriber unit 1 and the radio port control unit 3. In which, the radio port 2 is only in charge of the data transformation between the subscriber unit 1 and the radio port control unit 3. It should be noted that SIC can be divided into an SIC header and an SIC body. In which, the SIC header includes an SIC revision number, a Service Provider ID (SPID), and a service capability and security menu. The SIC body includes a Registration Area ID (RAID) and parameters correlating to the communication protocol.

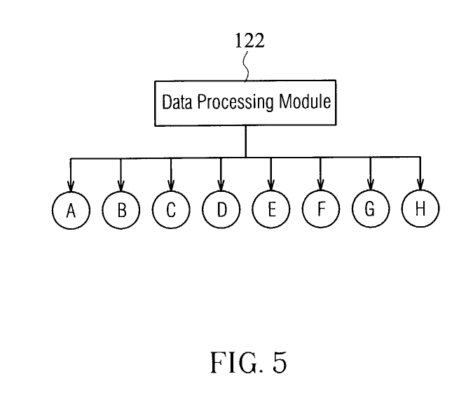

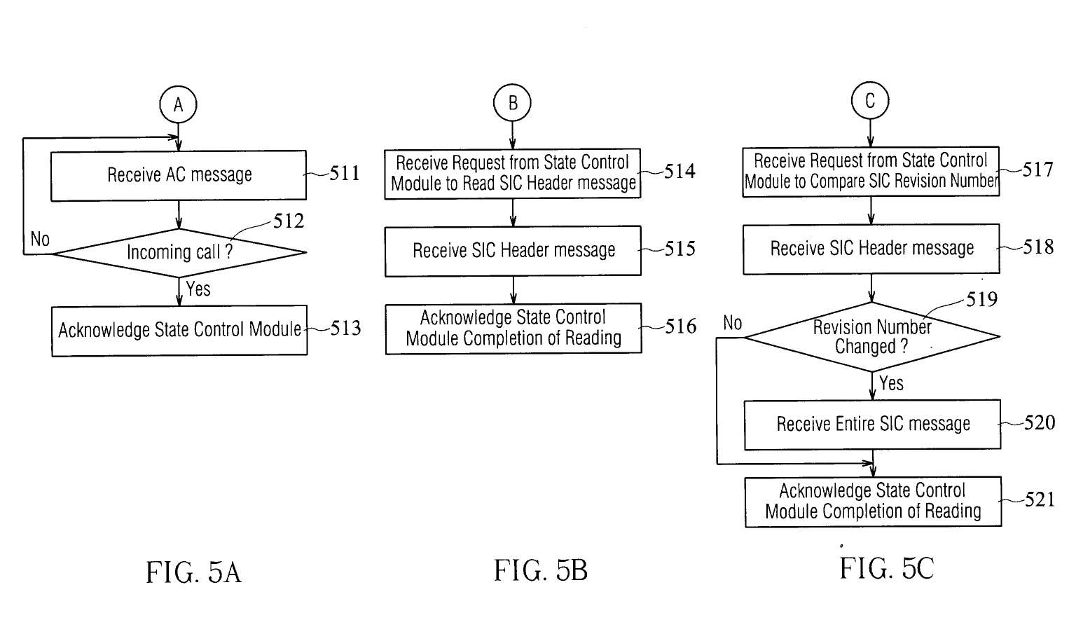

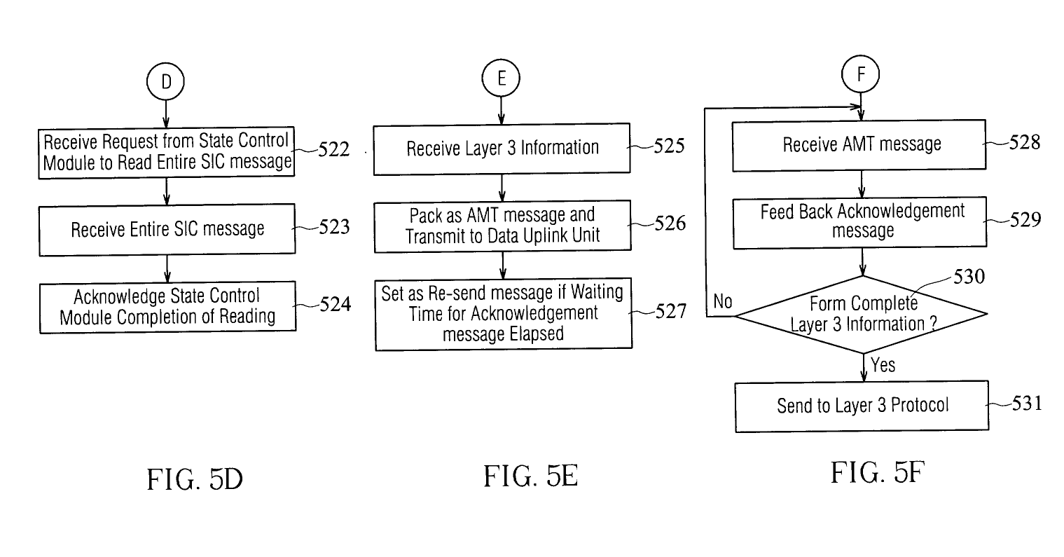

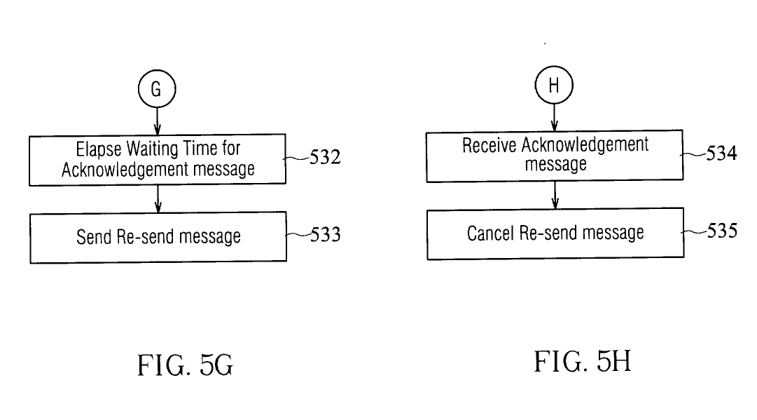

As shown in FIG. 5, under any states of the state control module 122, the data processing module 123, based on the message received, carries out eight corresponding events. FIGS. 5A to 5H illustrate each of the events, respectively.

As shown in FIG. 5A, when the data processing module 123 receives AC message downlink from the radio port control unit 3 at step 511, it checks whether the message contains the alerting ID of the subscriber unit 1 at step 512. If it does, this indicates an incoming call. Step 513 at the mean time through the state control module 122 acknowledges Layer 3 Protocol 13 to proceed to the procedure of answering the call.

As illustrated in FIG. 5B, at step 514, the data processing module 123 receives a request from the state control module 122 to read the SIC header. It then commences to receive the message of SIC header at step 515. When the reception is completed, the data processing module 123 acknowledges the state control module 122 at step 516 that the reading has been completed.

In FIG. 5C, when the data processing module 123 receives a request from the state control module 122 at step 517 to compare the revision number of the current SIC message, step 518 starts to receive message of SIC header. In step 519, it compares the SIC revision number with the previous one. If the SIC revision number has not been changed, it is not necessary to re-read the SIC message. It acknowledges the state control module 122 directly that reading has been completed at step 521. If the SIC revision number has been changed, the entire SIC message must be read at step 520 before proceeding to step 521 to acknowledge the state control module 122 the completion of the reading.

In FIG. 5D, the data processing module 123 receives a request from the state control module 122 at step 522 to read the entire SIC message. After completing the reception of the entire SIC message at step 523, it acknowledges the state control module 122 at step 524 the completion of the reading.

In FIG. 5E, after the data processing module 123 receives information from Layer 3 Protocol 13 at step 525, the information is packed as AMT communication protocol and transmitted the AMT message to the data uplink unit 1211 at step 526. When the message is transmitted in AMT communication protocol, it has to receive acknowledgement message from the receiver (that is the radio port control unit 3) before proceeding to transmit the next message. The message is set as re-send one at Step 527 if the waiting time for acknowledgement message has elapsed, in order to acknowledge re-sending of the message.

In FIG. 5F, at step 528, the data processing module 123 receives AMT message from the data downlink unit 1212. At step 529, it first feeds back acknowledgement message to the transmitter (that is the radio port control unit 3). At step 530, the data processing module 123 checks if complete information acceptable by the Layer 3 Protocol 13 has been formed. If it has, go to step 531 to transmit the information to Layer 3 Protocol 13. Otherwise, loop back to step 528 and keep on receiving AMT message.

In FIG. 5G, after transmitting AMT message to the data uplink unit 1211 at step 532, if time elapsed the waiting time for acknowledgement information, it then proceeds to step 533 to transmit the re-send message set earlier at step 527.

In FIG. 5H, when at step 534 an acknowledgement message is received from the receiver (i.e. the radio port control unit 3), step 535 is to cancel the re-send message set previously at step 527.

In the following descriptions, referring to FIG. 3, the information flow between each module in the Standby State and in the case of requesting for establishing communication channel will be explained in detail.

During the Standby State, the subscriber unit 1 receives only the AC message in SBC. The burst mode controller 111 receives downlink information and transmits the information to the downlink data queue 125. After the data downlink unit 1212 retrieves the downlink information from the queue 125 and transmits the AC message of information received to the data processing module 123 for analysis. If the data processing module 123 determines that the message is from the radio port control unit 3 indicating an incoming call, it informs the state control module 122, and the state control module 122 notifies the Layer 3 Protocol 13 about the message of an incoming call in order to proceed to the procedure of answering the call.

When the Layer 3 Protocol 13 requests the state control module 122 to establish TC (for making calls or answering an incoming call), the state control module 122 transmits the request of establishing TC to the priority information uplink queue 126. The BMC 111 retrieves the message from the queue and uplinks the message to the radio port control unit 3. After the radio port control unit 3 establishes a TC, it sends back a replying message to the BMC 111. The BMC 111 transmits the downlink information to the downlink data queue 125. The data downlink unit 1212 retrieves the information from the queue, determines that it is a priority message, and transmits it to the priority information downlink queue 127. The state control module 122 retrieves the replying message of the radio port control unit 3 from the queue 127, it then indicates the Layer 3 Protocol 13 that a TC has been established successfully.

When the Layer 3 Protocol 13 receives message replied from the state control module 122 that a TC has been established successfully, it starts to transmit layer 3 information. The flow of uplink information starts from the Layer 3 Protocol 13 sending the layer 3 message to the data processing module 123. The data processing module 123 partitions and packs the message as AMT communication protocol message and transmits them to the data uplink unit 1211. After the data uplink unit 1211 transmits the message to the uplink data queue 124, the BMC 111 retrieves the message from the queue and uplinks it to the radio port control unit 3. When downlink message, the flow of message starts from the BMC 111 transmitting message to the downlink data queue 125 after the information has been completed received. Data downlink unit 1212 then retrieves the downlink information and determines that it is AMT message, it transmits the message to the data processing module 123. The data processing module 123 repack the AMT message as layer 3 message and transmits it to the Layer 3 Protocol 13.

When the Layer 3 Protocol 13 is about to terminate the TC with the radio port control unit 3 (for example, the subscriber unit initiates a termination during the Active State, or the subscriber unit receives a termination message from the remote site), it notifies the state control module 122 to release the TC established earlier. The state control module 122 sends the message for releasing TC to priority information uplink queue 126. The BMC 111 retrieves the message from the queue 126 and uplinks it to the radio port control unit 3, which completes the process of releasing the traffic channel.

To sum up, the data link control device of the invention uses the modularized concept to manage and control the state management and data transmission of a subscriber unit separately. It uses a state control module to centrally maintain states of a subscriber unit. According to each state and its relative message received, the data link control device of the invention alters the state and its corresponding process, and uses a data processing module and a media access control module having a data uplink unit and a data downlink unit to carry out the classified process of priority procedure and regular procedure for message during the course of uplink and downlink information so that message with higher priority will be processed first. Further, it systematically controls the flow of message, and therefore can effectively establish and maintain data link, and increase the quality of telephone communication.

While the invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the invention.

What is claimed is:

1. A data link control device, which is implemented in a Layer 2 Protocol of a subscriber unit, in order to establish and maintain data links between the subscriber unit and a radio port or a radio port control unit, wherein the Layer 2 Protocol is located between a Layer 1 Protocol and a Layer 3 Protocol, and the data link control device comprises:
a state control module, which controls flow of states of the subscriber unit during data transmission between Layer 1 Protocol and Layer 3 protocol, and during uplink and downlink data to and from the radio port control unit, it sends Layer 2 Protocol message with higher priority to Layer 1 Protocol for processing;
a media access control module, which uplinks and downlinks data to and from the radio port control unit, and first transmits message from Layer 1 Protocol regarding Layer 2 Protocol to the state control module for corresponding process; and
a data processing module, which receives message downlinks from the radio port control units, and according to the message and requests from the state control module, carries out corresponding actions to the state control module, and the data processing module uses an assigned communication protocol through the media access control module to carry out uplink and downlink to and from the radio port control unit, in order to transmit information of Layer 3 Protocol between the subscriber unit and the radio port control unit, and further to instruct information receiver to feed back the correctness of the information.

2. The data link control device of claim 1, wherein the media access control module comprises:
a data uplink unit, which splits the uplink information received by the data processing module into suitable length, and transmits it to the Layer 1 Protocol; and
a data downlink unit, which receives the information downlink from the Layer 1 Protocol, transmits it to the data processing module and first transmits Layer 2 Protocol information to the state control module.

3. The data link control device of claim 1, wherein Layer 2 Protocol message comprises message of requests for establishing (or seizing) traffic channel, acknowledgements of processing automatic link transfer or time slot transfer, and priority request control.

4. The data link control device of claim 2, wherein the assigned communication protocol is acknowledged mode transfer (AMT) communication protocol.

5. The data link control device of claim 2, further comprises:
an uplink data queue, which stores uplink information transmitted from the data uplink unit to the Layer 1 Protocol; and
a downlink data queue, which stores downlink information transmitted from the Layer 1 Protocol to the data downlink unit.

6. The data link control device of claim 2, further comprises:
a priority information uplink queue, which stores message regarding Layer 2 Protocol transmitted from the state control module to the Layer 1 Protocol; and
a priority information downlink queue, which stores message regarding Layer 2 Protocol transmitted from the Layer 1 Protocol to the state control module.

7. The data link control device of claim 1, wherein data transmission between the subscriber unit and the radio port control unit is through the radio port.

8. The data link control device of claim 1, wherein message downlink from the radio port control unit to the data processing module comprises system information channel (SIC) message and alerting channel (AC) message.

9. The data link control device of claim 8, wherein the data processing module, according to the AC message received, judges whether or not there is an incoming call, and the state control module uses this judgment to acknowledge Layer 3 Protocol whether or not to proceed to answering the call.

10. The data link control device of claim 8, wherein the data processing module based on the SIC message received checks the SIC message until reception is completed before acknowledging the state control module the completion of the reception.

11. The data link control device of claim 4, wherein the data processing module receives information from the Layer 3 Protocol, packages it as message of the AMT communication protocol, and then transmits it to the data uplink unit and waits for acknowledgment message feedback from the radio port control unit.

12. The data link control device of claim 4, wherein the data processing module receives message of the AMT communication protocol from the data downlink unit, packages it into complete information acceptable by the Layer 3 Protocol, and feeds back an acknowledgment message to the radio port control unit.
